(19) United States
(12) Patent Application Publication
(10) Pub. No.: US 2023/0250263 A1
(43) Pub. Date: Aug. 10, 2023

(54) PLASTICIZED CELLULOSE ESTER COMPOSITIONS

(71) Applicant: Eastman Chemical Company, Kingsport, TN (US)

(72) Inventors: Robert Erik Young, Kingsport, TN (US); Michael Eugene Donelson, Kingsport, TN (US)

(73) Assignee: Eastman Chemical Company, Kingsport, TN (US)

(21) Appl. No.: 18/000,717

(22) PCT Filed: Jun. 3, 2021
(86) PCT No.: PCT/US2021/035598

§ 371 Date: Dec. 5, 2022

Related U.S. Application Data
(60) Provisional application No. 63/035,905, filed on Jun. 8, 2020.

(51) Int. Cl. C08L 1/14; C08L 1/12; C08L 91/00; C08K 5/11; E04F 15/10

(52) U.S. Cl. CPC C08L 1/14; C08L 1/12; C08L 91/00; C08K 5/11; E04F 15/107; C08L 2201/10; C08L 2205/025; C08L 2205/03

(57) ABSTRACT

Disclosed is a plasticized cellulose ester composition. The plasticized cellulose ester composition of the present invention includes at least one cellulose ester and a plasticizer system. The plasticizer system includes epoxidized bio-derived oil in an amount of from 2% to 32% by weight based on the total weight of the plasticizer system. Flooring articles with at least one layer formed from the composition are also described.

### FIELD OF THE INVENTION

The present invention generally relates to plasticized cellulose ester compositions as well as articles formed from said compositions.

### BACKGROUND OF THE INVENTION

As the chemical industry and consumers look for environmentally friendly alternatives to certain chemicals, the growth of cellulose esters has increased significantly. Cellulose esters are bio-derived compounds, more particularly plant-based compounds derived from cellulose, a polysaccharide found in wood, plants and plant products such as cotton. Cellulose esters have been used in a wide variety of end-product uses such as coatings and coating ingredients, objects such as eyeglass frames, disposable knives, forks, spoons, plates, cups and straws, toothbrush handles automotive trim, camera parts and disposable syringes. Cellulose esters also have intermediate uses product uses, often in the form of fibers, films, sheets and the like. Published studies indicate that the cellulose esters market is projected to grow from USD 9.27 billion in 2018 to USD 12.43 billion by 2023, at a CAGR of 6% from 2018 to 2023, with the coatings market projected to lead the growth.

Despite this growth, it acknowledged in the art that challenges exist in utilizing cellulose esters in certain applications. For example, it is noted in U.S. Published Patent Application No. 2016/0068656 that, while cellulose esters are generally considered environmentally-friendly polymers and derived from renewable sources like wood pulp, they have not been widely used in plastic compositions due to processing difficulties. The '656 patent continues by referencing the absence of cellulose esters in injection molded articles and assert that this absence is due, at least in part, to the narrow temperature window between the melting point and the decomposition temperature of cellulose esters. The fact that production of film and sheet with cellulose esters has historically been limited to standard extrusion and solvent casting methods is also discussed in U.S. Published Patent Application Number 2019/0256674A1, assigned to the assignee of the present invention.

U.S. Published Patent Application No. 2016/0068656 purports to address this drawback by claiming a cellulose ester plastic that includes a cellulose ester at about 20% to about 90% by weight of the cellulose ester plastic; and a plasticizer that comprises a carbonate ester, a polyol benzoate, or both, wherein the plasticizer is at about 2% to about 40% by weight of the cellulose ester plastic, wherein the cellulose ester plastic is melt processable. Similarly, U.S. Pat. No. 4,325,997 describes a processable cellulose ester composition that includes least one cellulose ester plastic of the group consisting of cellulose acetate, cellulose propionate, cellulose butyrate, cellulose acetate propionate and cellulose acetate butyrate and (2) about 5 to parts by weight of an acid accepting liquid epoxy compound per 100 parts by weight of said cellulose ester plastic. Also, U.S. Published Patent Applications 2020/0056011A1 and 2019/0256674A1, both assigned to the assignee of the present invention, describe cellulose ester compositions that, while processable without plasticizers, may include them. The contents and disclosure of U.S. Published Patent Applications 2020/0056011A1 and 2019/0256674A1 are hereby incorporated herein by reference.

In line with and furthering the use of bio-derived, environmentally friendly materials such as cellulose esters is the desirability for using bio-derived, environmentally friendly ingredients in cellulose ester compositions. U.S. Pat. No. 2,744,026, in describing a plasticized cellulose acetate butyrate, discloses that cotton seed oils possess objectionable odors and are likely to become rancid on aging while vegetable oils, such as linseed and soybean oil, have limited compatibility in ethyl cellulose. More recently, this compatibility problem is acknowledged for example in a manufacturer's published data sheet for epoxidized soybean oil, listing it as “incompatible” with cellulose acetate and cellulose acetate propionate. It is known in the art that one manifestation of such incompatibility is haze, a result undesirable for almost all end-use applications of cellulose ester formulations.

A continuing unmet need therefore exists for easily, efficiently and cost-effectively processable cellulose ester compositions that minimize the presence of haze while maximizing the content of bio-derived and/or plant-based and/or environmentally friendly content.

### SUMMARY OF THE INVENTION

In a first aspect, the present invention relates to a plasticized cellulose ester composition including at least one cellulose ester and a plasticizer system wherein the plasticizer system includes epoxidized bio-derived oil in an amount of from 2% to 32% by weight based on the total weight of said plasticizer system.

In another aspect, the present invention relates to a calendered article formed from a plasticized cellulose ester composition including at least one cellulose ester and a plasticizer system wherein the plasticizer system includes epoxidized bio-derived oil in an amount of from 2% to 32% by weight based on the total weight of said plasticizer system.

In yet another aspect, the present invention is directed to a flooring article including at least one layer, wherein the layer includes at least one cellulose ester and a plasticizer system, with the plasticizer system comprising epoxidized bio-derived oil in an amount of from 2% to 32% by weight based on the total weight of said plasticizer system.

In still another aspect, the present invention is directed to a plasticized polymer flooring article of a least one layer including at least one plasticizer and at least one polymer, wherein at least 77% by weight or at least 84% of the total sum weight of the plasticizer plus the polymer is bio-derived material.

Further aspects of the invention are as disclosed and claimed herein.

### BRIEF DESCRIPTION OF THE DRAWINGS

FIG. 1 is a graphical representation of unexpected benefits achieved by the present invention; and

FIG. 2 is a side elevational view of an embodiment of a multilayer resilient flooring article of the present invention.

### DETAILED DESCRIPTION

For avoidance of doubt, it is expressly provided for that the information and descriptions herein regarding features or elements of one aspect of the present invention are asserted as applicable to and relied on to support those features and elements when described with regard to all other aspects of the invention.

In a first aspect, the present invention is directed to a plasticized cellulose ester composition. The plasticized cellulose ester composition of this aspect of the present invention includes at least one cellulose ester and a plasticizer system. The plasticizer system includes epoxidized bio-derived oil in an amount of from 2% to 32% by weight based on the total weight of said plasticizer system. More particularly, the plasticizer system may include epoxidized bio-derived oil in an amount of from 5% to 30% by weight based on the total weight of said plasticizer system.

The plasticized cellulose ester composition of the present invention includes at least one cellulose ester. A cellulose ester is a bio-derived polymeric material and is generally defined to include cellulose esters of one or more carboxylic acids and are described for example in U.S. Pat. No. 5,929,229, assigned to the assignee of the present invention, the contents and disclosure of which are incorporated herein by reference. Non limiting examples of cellulose esters include cellulose acetate, cellulose propionate, cellulose butyrate, so-called mixed acid esters such as cellulose acetate propionate and cellulose acetate, and combinations thereof. In one or more embodiments, the cellulose ester is chosen from the group consisting of cellulose acetate, cellulose acetate propionate and cellulose acetate butyrate and combinations thereof. In one or more embodiments, the cellulose ester is cellulose acetate. In one or more embodiments, the cellulose ester is cellulose acetate propionate. In one or more embodiments, the cellulose ester is cellulose acetate butyrate. In one or more embodiments, the cellulose ester is a combination of cellulose acetate propionate and cellulose acetate butyrate.

In one or more embodiments, the at least one cellulose ester is a combination of two or more cellulose esters.

In one or more embodiments, the amount of cellulose ester in the plasticized cellulose ester composition is between 25% and 99% by weight, or between 35% and 99%, or between 45% and 99%, all based on the total weight of the plasticized cellulose ester composition.

The cellulose ester of the present invention may be characterized using one or more characteristics. For example, in one or more embodiments, the cellulose ester has a number average molecular weight (“Mn”) that is in the range of from 20,000 Da to 100,000 Da. In one or more embodiments, the cellulose ester has a Mn that is in the range of from about 20,000 Da to about 80,000 Da.

The cellulose ester may have a solution ball-drop viscosity of 2 to 30 or 4 to 25 or 5 to 20 seconds as measured by ASTM D817.

The cellulose ester may have in one or more embodiments a hydroxyl degree of substitution (DSOH) of from 0.1 to 0.8; an acetyl degree of substitution of from of from 0.1 to 0.8; a propionyl degree of substitution (DSPR) of from 1.4 to 2.8; or alternative to the propionyl, a butyryl degree of substitution (DSBU) of from 1.4 to 2.8. By way of brief background, DSOH, DSAC, DSPR and DSBU are measures of the degree of esterification for a given cellulose ester. Cellulose has three hydroxyls per anhydroglucose unit, located at the C2, C3 and C6 carbons, that can be esterified to varying degrees and in different ratios with various acyl groups, with the specific type of cellulose ester formed depending on the functionalization of the hydroxyl groups. Cellulose acetate propionate of this invention may have a DSAC of approximately 0.2, a DSPR of approximately 2.5 and a DSOH of approximately 0.3. Cellulose acetate butyrate of the present invention may have a DSAC of approximately 1.0, a DSBU of approximately 1.7 and a DSOH of approximately 0.3.

The cellulose ester may in one or more embodiments have a glass transition temperature (Tg) of 50° C. to 150° C. or from 70° C. to 120° C. or no more than 160° C.

The cellulose ester may in one or more embodiments have a percent crystallinity of less than 20% or less than 15% or less than 10% or less than 5% or from 5% to 10% or from 5% to 15% or from 5% to 20% or from 10% to about 20%. Crystallinity is described herein using and measured in the context of the present invention from, the second heat cycle in accordance with ASTM D3418 and assuming an enthalpy of melting of 14 cal/g for the cellulose esters. In this method, the amount of crystallinity is measured under a prescribed heating history, more particularly the “2nd cycle” cooling and heating in a differential scanning calorimeter (DSC) per ASTM D3418. In this method, the sample is first heated in the DSC to above its melting temperature to erase any prior crystallinity (i.e. the “first heat cycle”). Next the sample is cooled at 20 degrees C. per minute to below Tg, and then reheated at the same rate to above the melting temperature again (the “2nd heat cycle”). During this cooling and 2nd heating, the material will recrystallize to a certain degree, and this amount of crystallization is measured in the scan as the enthalpy of melting at the melting temperature.

The plasticized cellulose ester composition of the present invention includes a plasticizer system. The term “system” as used herein is broadly intended to include a singular plasticizer such as employed in control formulations in the examples herein as well as two or more plasticizers in combination, more particularly plasticizer combinations of the present invention that include epoxidized bio-derived oil. The amount of the plasticizer system in the plasticized cellulose ester composition may vary depending on a number of factors, including type and amount of the at least one cellulose ester, but should be sufficient to render the composition plasticized as evidenced by for example a reduction in modulus or glass transition temperature (Tg). In one or more embodiments, the amount of the plasticizer system in the plasticized cellulose ester composition is 10% to 35% by weight based on the total weight of the composition or 15% to 30% by weight based on the total weight of the composition.

The plasticizer system in the plasticized cellulose ester composition includes epoxidized bio-derived oil, preferably in an amount of in an amount of from 2% to 32% by weight or from 5% to 30% by weight of the plasticized system based on the total weight of said plasticizer system. In one or more embodiments, the amount of epoxidized bio-derived oil is more than 3% by weight of the plasticized cellulose ester composition based on the total weight of the plasticized cellulose ester composition. “Bio-derived oil” is intended to include all oils or similar materials derived from a renewable resource such as plants, trees, algae, enzymes, microorganisms and the like. Non-limiting examples of bio-derived oils useful as a component of the plasticizer system of the present invention include epoxidized soybean oil, epoxidized linseed oil and epoxidized tall oil. In one or more embodiments of the present invention, the epoxidized bio-derived oil is epoxidized soybean oil or the plasticizer system includes epoxidized soybean oil. Epoxidized soybean oil is known in the art and is commercially available for example from Arkema under the trade name Vikoflex™ 7170 and from Galata Chemicals under the trade name Drapex™ 6.8. Epoxidized soybean oil and methods for its manufacture are described for example in U.S. Pat. Nos. 3,655,698 and 4,215,058, the contents and disclosure of which are incorporated herein by reference.

The plasticizer system of the plasticized cellulose ester composition of the present invention may further include at least one non-epoxidized plasticizer. The choice of non-epoxidized plasticizer may vary depending on a number of factors, including for example the amount and type of cellulose ester or esters used, the amount of epoxidized bio-derived oil in the system and the targeted end-use for the composition. Families of non-epoxidized plasticizers useful for the present invention include phthalates, fatty acid esters (i.e., oleates, adipates, fumarates. sebacates, maleates, succinates), polyalcohol ethers or esters (i.e., esters of glycerol, esters or ethers of polyethylene glycol), benzoates, azelates, citrates, phosphates, trimellitates (i.e., trimellitic acid tributyl ester, trioctyl trimellitate), and the like. In one or more embodiments, the non-epoxidized plasticizer is selected from the group consisting of an aromatic phosphate ester plasticizer, alkyl phosphate ester plasticizer, dialkylether diester plasticizer, tricarboxylic ester plasticizer, polymeric polyester plasticizer, polyglycol diester plasticizer, polyester resin plasticizer, aromatic diester plasticizer, aromatic triester plasticizer, aliphatic diester plasticizer, carbonate plasticizer, benzoate plasticizer, polyol benzoate plasticizer adipate plasticizer, a phthalate plasticizer, a glycolic acid ester plasticizer, a citric acid ester plasticizer, a hydroxyl-functional plasticizer, or a solid, non-crystalline resin plasticizer and combinations thereof. In one or more embodiments, the at least one non-epoxidized plasticizer includes triethylene glycol bis (2-ethyl hexanoate) or the plasticizer system includes triethylene glycol bis (2-ethyl hexanoate).

An important feature of the plasticized cellulose ester composition of the present invention is that in one or more embodiments it may exhibit reduced haze as tested according to ASTM D-1003-13 compared to a control material formed from the same composition as the plasticized cellulose ester composition but without the epoxidized bio-derived oil in the plasticizer system. Accordingly, in one or more embodiments, the plasticized cellulose ester composition of the present invention exhibits reduced haze as tested according to ASTM D-1003-13 compared to a control material formed from the same composition as said plasticized cellulose ester composition but without said epoxidized bio-derived oil in the plasticizer system.

The composition of the present invention may further include one or more of processing aids, impact modifiers and roll release agents. In one or more embodiments, the plasticized cellulose ester composition of the present invention may include at least one roll release agent. Suitable roll release agents are known in the art and are described for example in U.S. Pat. No. 6,551,688, the contents and disclosure of which are incorporated herein by reference. Examples of suitable roll release agents include without limitation lubricants, exemplified by waxes such as amide waxes, fatty acids, fatty acid esters, fatty acid salts, saponified fatty acid salts and combinations thereof. Examples of a fatty acid esters include esters of montanic acid. In one or more embodiments, the roll release agent is a fatty acid ester selected from the group consisting of butylene glycol ester of montanic acid, glycerol ester of montanic acid, pentaerythritol ester of montanic acid and combinations thereof.

When roll release agents are included in the present invention, they are typically present in an amount of about 0.1% to about 2.0% roll release agent by weight based on the total weight of the composition. In one or more embodiments, the composition of the present invention includes 0.1% to 1.0% by weight roll release agent based on the total weight of the composition. In one or more embodiments, the composition of the present invention includes 0.1% to 0.5% by weight roll release agent based on the total weight of the composition. In one or more embodiments, the composition of the present invention includes 0.5% to 1.0% by weight roll release agent based on the total weight of the composition. In one or more embodiments, the composition of the present invention includes 1.0% to 2.0% by weight roll release agent based on the total weight of the composition. In one or more embodiments, the composition of the present invention includes 1.5% to 2.0% by weight roll release agent based on the total weight of the composition.

The present invention may further include at least one processing aid. Processing aids may for example improve the texture and “fusion” of the melt, improve melt strength, reduce composition melting time, reduce overall processing time and help with metal release from calendering rolls. Processing aids are known in the art and may be derived for example from acrylics, and acrylic copolymers although processing aids based on styrenics, carbonates, polyesters, other olefins, siloxanes, and combinations thereof, and are known and commercially available. Suitable processing aids are commercially available and include without limitation Paraloid™ K-125 available from Dow; Kane-Ace® PA-20, PA-610, B622, MR01 and MP90 available from Kaneka Corporation; and Ecdel™ available from Eastman Chemical Company. In one or more embodiments, the processing aid includes one or more of acrylic polymer, an acrylic copolymer, a styrenic polymer, a carbonate polymer, a polyester polymer, an olefin polymer and a siloxane polymer. In one or more embodiments, the processing aid is selected from the group consisting of an acrylic polymer, an acrylic copolymer and combinations thereof. In one embodiment, the processing aid comprises a Kane-Ace® acrylic processing aid.

The amount of the at least one processing aid present in the present invention may vary depending on for example, the type of processing aid and its molecular weight and viscosity, the other components of the composition and the composition's end-use application. When processing aids are included in the present invention, they are typically present in an amount of 0% to about 3.0% by weight processing aid based on the total weight of the composition. In one or more embodiments, the composition of the present invention includes 0.1% to 6.0% by weight processing aid based on the total weight of the composition. In one or more embodiments, the composition of the present invention includes 0.5% to 6.0% by weight processing aid based on the total weight of the composition. In one or more embodiments, the composition of the present invention includes 0.5% to 3.0% by weight processing aid based on the total weight of the composition.

The present invention may also include at least one impact modifier. Examples of impact modifiers include core-shell polymers based on acrylics, including acrylic polymers, methacrylate butadiene styrene (MBS) polymers, silicone-acrylic polymers and combinations thereof. Other suitable impact modifiers include acrylonitrile-butadiene styrene (ABS), ethylene vinyl acetate copolymers, chlorinated polyethylenes, ethylene copolymers and combinations thereof. Impact modifier, if present, is typically present in the composition of the present invention in an amount of 1% to about 20% by weight impact modifier based on the total weight of the composition.

The composition of the present invention may further include one or more other ingredients or components such as for example other polymers such as acrylics; fillers such as calcium carbonate, talc, glass beads and glass fibers; flame retardants, lubricants, pigments, dispersing aids, biocides, antistatic agents, water repelling additives, rodenticides, dyes, colorants and the like.

In one or more embodiments, the composition of the present invention is suitable for or capable of forming a calendered article such as a sheet or film. Accordingly, in an aspect, the present invention relates to a calendered article comprising a plasticized cellulose ester composition that includes at least one cellulose ester and a plasticizer system, wherein the plasticizer system includes epoxidized bio-derived oil in an amount of from 2% to 32% by weight based on the total weight of said plasticizer system. As previously noted, information and description set forth in regard to features and elements of the plasticized cellulose ester composition aspect of the present invention are intended to apply to and fully all other aspects of the invention including this calendered article aspect.

By use of the phrase “calendered article” the present invention intends to describe articles such as films or sheets formed using a calendering method with a molten polymer wherein the molten polymer is forced through the nips of counterrotating rolls to form a film or sheet and gradually squeezed down to a film or sheet of final thickness by optionally passing through additional rolls having a similar counterrotating arrangement (with the roll arrangements typically referred to as a “stack”). The film or sheet may be subjected to additional treatment, such as for example stretching, annealing, slitting or the like, with the final article then wound on a winder. Calendering and calendered articles as used herein are described in more detail in U.S. Published Patent Application No. 2019/0256674, assigned to the assignee of the present invention, the contents and disclosure of which are incorporated herein by reference.

In one or more of these embodiments, the plasticized cellulose ester composition has a melt viscosity according to ASTM 3835 of 1000 Poise to 5000 Poise or 2000 Poise to 5000 Poise at a temperature of 190° C. and a shear rate of 628 s⁻¹. In one or more of these embodiments, the plasticized cellulose ester composition of the present invention is capable of being calendered at the temperature range of the sum of the glass transition temperature of the cellulose ester of the composition plus 20° C. to the sum of the glass transition temperature of the cellulose ester of the composition plus 100° C. With a view toward these embodiments, an aspect of the present invention is a calendered article formed from the plasticized cellulose ester composition of the present invention, particularly wherein the calendered article is a film or sheet and more particularly wherein the calendered article is a sheet or film that useful as of that forms a layer of a multilayer resilient flooring article.

Though the preceding aspect of the present invention describes a utility of the plasticized cellulose ester composition of the present invention in the field of calendering and calendered articles, one of ordinary skill in the art will appreciate that the composition of the present invention may also be useful in forming articles by other known methods, such as for example extrusion, injection molding, blow-molding, additive manufacturing (3D printing), profile extrusion, blown film, multilayer film, sheet lamination and the like.

The plasticized cellulose ester composition of the present invention may be useful in forming a flooring article, a calendered flooring article or more particularly a layer of a flooring article or a calendered layer of a flooring article. Accordingly, in another aspect, the present invention is directed to a flooring article. The flooring article of this aspect of the present invention includes at least one layer. In one or more embodiments, the at least one layer is a calendered layer. In one or more embodiments, the at least one layer is formed from the plasticized cellulose ester composition of the present invention. Accordingly, the at least one layer includes at least one cellulose ester and a plasticizer system with the plasticizer system including epoxidized bio-derived oil in an amount of from 2% to 32% by weight based on the total weight of said plasticizer system. Flooring articles contemplated as within the scope of present invention include without limitation any material or construction intended for use as, installation on or application to a walking surface or lower surface of a room or building. Non-limiting examples of flooring articles include rolled flooring, squares, tiles, planks, sheet, laminates and the like which may be installed for example as a so-called “floating” floor or a glued-down floor assembly. As previously noted, information and description set forth in regard to features and elements of the plasticized cellulose ester composition aspect or other aspects of the present invention are applicable to and intended to fully support this aspect directed to flooring articles.

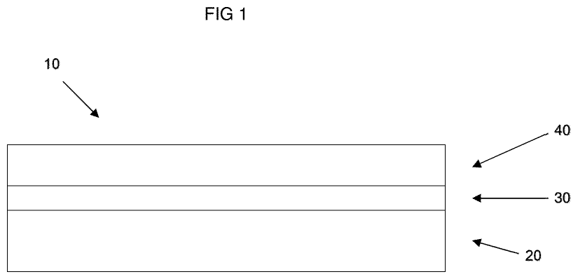

In one or more embodiments, the flooring article is a resilient flooring article. In one or more embodiments, the resilient flooring article is a multilayer resilient flooring article or a laminated flooring article. In a non-limiting exemplary embodiment of a multilayer resilient flooring article depicted in FIG. 1, the multilayer resilient flooring article 10 of the present invention includes a core layer 20 and a top layer 40. The multilayer resilient flooring article may also include an optional print layer 30 between the core layer 20 and the top layer 40. The top or wear layer 40 provides scratch and abrasion resistance while also allowing for visibility through the top surface of any underlying print layer design and typically has a thickness of between 15 mils and 25 mils. The base or core layer 20 provides dimensional stability and typically has a thickness of a thickness of at least 75 mils. The print layer 30 may provide a visual color and/or design, for example in the form of geometric patterns or images, and typically has a thickness of between 3 mils and 5 mils.

As discussed elsewhere herein, the core layer 20, top layer 40 and print layer may each be a calendered sheet or a calendered film. Other optional layers, such as removable backing layers, adhesive layers and the like, may also be included. Multilayer resilient flooring articles on the type contemplated herein are generally known in the art and are described for example in U.S. Pat. No. 8,071,193, the contents and disclosure of which are incorporated herein by reference.

In one or more embodiments, the flooring article of the present invention may be a multilayer resilient flooring article that includes at least one layer of the plasticized cellulose ester composition of the present invention. In one or more embodiments, the at least one layer is a calendered layer or a calendered sheet or a calendered film. In one or more embodiments wherein the multilayer resilient flooring article includes a wear layer, the flooring article of the present invention may be a multilayer resilient flooring article that includes a wear layer of the plasticized cellulose ester composition of the present invention. In one or more embodiments wherein the multilayer resilient flooring article includes a print layer, the flooring article of the present invention may be a multilayer resilient flooring article that includes a print layer of the plasticized cellulose ester composition of the present invention. In one or more embodiments, the flooring article is a multilayer resilient flooring article comprising a wear layer, a core layer and a print layer with the flooring article comprising a wear layer and a print layer both of the plasticized cellulose ester composition of present invention.

An important feature of the present invention is its environmentally desirable increased use of bio-derived content in calendered sheets and films, flooring articles and flooring article layers that typically include at least one polymer and at least one plasticizer or a plasticizer system. Accordingly, in another aspect, the present invention is directed to a plasticized polymer flooring article of a least one layer that includes at least one plasticizer or a plasticizer system and at least one polymer, wherein at least 77% by weight or at least 84% by weight of the total sum weight of the plasticizer system plus the polymer of the layer is bio-derived material. As noted elsewhere herein, information and description in regard to features and elements of one or more aspects of the present invention are applicable to and intended to fully support features and elements of all other aspects including this aspect.

The following examples, while provided to illustrate with specificity and detail the many aspects and advantages of the present invention, are not be interpreted as in any way limiting its scope. Variations, modifications and adaptations which do depart from the spirit of the present invention will be readily appreciated by one of ordinary skill in the art.

To demonstrate the present invention, 8 formulations of the plasticized cellulose ester composition of the present invention (formulation #s 2-9) were formulated as indicated in Table 1 below, along with a control material (formulation #1) which includes all the ingredients of the compositions of the present invention except that the plasticizer system did not include epoxidized soybean oil but was the singular plasticizer triethylene glycol bis(2-ethyl hexanoate) (TEG2EH). Other formulations that include epoxidized soybean oil but are not contemplated as within the scope of the present invention (formulation #s 10-13) were also prepared. In all examples, total plasticizer content was held constant at 22% by weight based on the total weight of the composition. Stated another way, the plasticizer system amount for the composition was held constant at 22% by weight based on the total weight of the composition. In forming the example and control compositions, formulations were weighed on Toledo-Mettler top loading balance to a total mass of 150 grams, placed in a polyethylene bag and then shaken until the mixture appeared uniform. Samples were placed on a Dr. Collin Two Roll Mill. The front-roll temperature was set at 170° C. and the back-roll temperature was set at 165° C. The material was placed on the mill, the roll speed was set at 10 rpm and the time from when the powdered material was placed on the mill to when it achieved a plastic form was recorded. Data was recorded at 10 and 20 rpm for front and rear roll torque and roll separating force. The compositions were then removed from the mill in the form of an article (a continuous film) at a thickness of 0.010″ (250 microns) and allowed to cool.

Formulation component information is as follows:

CAP 482-20 is a high viscosity cellulose acetate propionate available from Eastman Chemical Company with a solution ball-drop viscosity of 20 seconds as measured by ASTM D817. Drapex™ 6.8 is an epoxidized soybean oil (ESO) available from Galata Chemicals. Vicoflex™ V7170 is an epoxidized soybean oil (ESO) available from Arkema. Triethylene glycol bis(2-ethyl hexanoate) (TEG2EH) is a plasticizer available from Eastman Chemical Company. PA20™ is a medium molecular weight process aid available from Kaneka. Licowax™ OP is a wax, more particularly a partially saponified calcium salt of montanic acids and is available from Clariant Corporation.

As shown in detail in Table 1, amounts of CAP 482, PA20 and Licowax OP were held constant with each formulation and the total plasticizer amount (pz %) was held constant at 22% by weight. Within the plasticizer system, which included TEG2EH and epoxidized soybean oil, the levels of the TEG2EH and ESO were varied across the formulations. As shown, the control sample (sample 1) included a plasticizer system that included TEG2EH as a single component.

TABLE 1

| | Additives | | | | | | | |
|---|---|---|---|---|---|---|---|---|
| Formulation | CAP | | Drapex | Vikoflex | Kaneka | Licowax | | |
| No. | 482-20 | TEG-2EH | 6.8 | 7170 | PA20 | OP | pz % | check % |
| 1 | 75.0% | 22.0% | 0.0% | 0.0% | 2.0% | 1.0% | 22.0% | 100.0% |
| 2 | 75.0% | 21.5% | 0.0% | 0.5% | 2.0% | 1.0% | 22.0% | 100.0% |
| 3 | 75.0% | 20.9% | 0.0% | 1.1% | 2.0% | 1.0% | 22.0% | 100.0% |
| 4 | 75.0% | 19.8% | 2.2% | 0.0% | 2.0% | 1.0% | 22.0% | 100.0% |
| 5 | 75.0% | 19.8% | 0.0% | 2.2% | 2.0% | 1.0% | 22.0% | 100.0% |
| 6 | 75.0% | 17.6% | 4.4% | 0.0% | 2.0% | 1.0% | 22.0% | 100.0% |
| 7 | 75.0% | 17.6% | 0.0% | 4.4% | 2.0% | 1.0% | 22.0% | 100.0% |
| 8 | 75.0% | 15.4% | 6.6% | 0.0% | 2.0% | 1.0% | 22.0% | 100.0% |
| 9 | 75.0% | 15.4% | 0.0% | 6.6% | 2.0% | 1.0% | 22.0% | 100.0% |
| 10 | 75.0% | 14.3% | 0.0% | 7.7% | 2.0% | 1.0% | 22.0% | 100.0% |
| 11 | 75.0% | 13.2% | 0.0% | 8.8% | 2.0% | 1.0% | 22.0% | 100.0% |
| 12 | 75.0% | 12.1% | 0.0% | 9.9% | 2.0% | 1.0% | 22.0% | 100.0% |
| 13 | 75.0% | 12.1% | 0.0% | 11.0% | 2.0% | 1.0% | 22.0% | 100.0% |

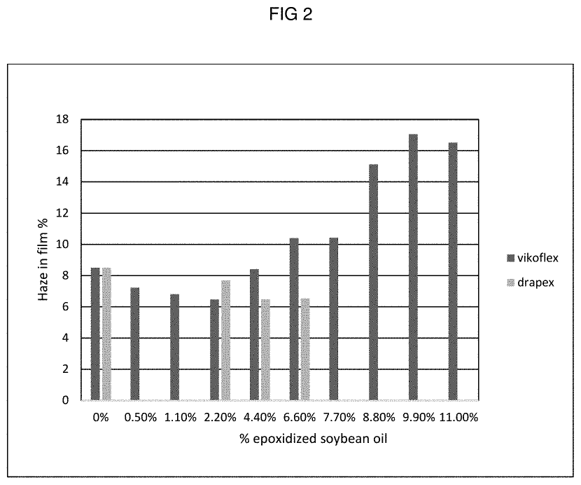

The compositions were formed as above and processed into 10-mil films were then tested for haze in accordance with ASTM D1003-13. The results of this testing are set forth in Table 2 below and depicted in FIG. 2.

TABLE 2

| | Formulation Number | | | | | | | | | | | | |
|---|---|---|---|---|---|---|---|---|---|---|---|---|---|
| | 1 | 2 | 3 | 4 | 5 | 6 | 7 | 8 | 9 | 10 | 11 | 12 | 13 |
| % Haze | 8.51 | 7.23 | 6.81 | 7.7 | 6.47 | 6.49 | 8.41 | 6.54 | 10.4 | 10.42 | 15.13 | 17.05 | 16.52 |

As clearly indicated in Table 2 and FIG. 2, the haze level of the plasticized cellulose ester compositions of the present invention was markedly and surprisingly lower than the control. Accordingly, the present invention achieved a clear and unexpected reduction in haze when compared to the control. Criticality of the level of epoxidized bio-derived oil present in the plasticizer system is also demonstrated by the haze levels shown in samples with relatively higher ESO levels.

The foregoing description of various embodiments of the invention has been presented for purposes of illustration and description. It is not intended to be exhaustive or to limit the invention to the precise embodiments disclosed. Numerous modifications or variations are possible in light of the above teachings. The embodiments discussed were chosen and described to provide the best illustration of the principles of the invention and its practical application to thereby enable one of ordinary skill in the art to utilize the invention in various embodiments and with various modifications as are suited to the particular use contemplated. All such modifications and variations are within the scope of the invention as determined by the appended claims when interpreted in accordance with the breadth to which they are fairly, legally, and equitably entitled.

1. A plasticized cellulose ester composition, said composition comprising (a) at least one cellulose ester; and a plasticizer system, said plasticizer system comprising epoxidized bio-derived oil in an amount of from 2% to 32% by weight of the plasticizer system on the total weight of said plasticizer system.

2. The composition of claim 1 wherein said composition comprises from 10% to 35% by weight of said plasticizer system based on the total weight of said composition.

3. The composition of claim 1 wherein said plasticizer system further comprises triethylene glycol bis (2-ethyl hexanoate).

4. The composition of claim 1 further comprising one or more of processing aids, impact modifiers and roll release agents.

5. The composition of claim 1 wherein said at least one cellulose ester is selected from the group consisting of cellulose acetate propionate and cellulose acetate butyrate.

6. The composition of claim 1 wherein said at least one cellulose ester is a combination of two or more cellulose esters.

7. The composition of claim 1 wherein said epoxidized bio-derived oil is epoxidized soybean oil.

8. The composition of claim 1 wherein said composition exhibits reduced haze as tested according to ASTM 1003-13 when compared to a control material formed from the same composition as said plasticized cellulose ester composition but without said epoxidized bio-derived oil in said plasticizer blend.

9. A calendered article formed from the composition of claim 1.

10. A flooring article comprising at least one layer, said layer comprising least one cellulose ester and a plasticizer system, said plasticizer system comprising epoxidized bio-derived oil in an amount of from 2% to 32% by weight based on the total weight of said plasticizer system.

11. The flooring article of claim 10 wherein said at least one layer comprises from 10% to 35% by weight of said plasticizer system based on the total weight of said composition.

12. The flooring article of claim 10 wherein said plasticizer system further comprises triethylene glycol bis (2-ethyl hexanoate).

13. The flooring article of claim 10 wherein said at least one cellulose ester is selected from the group consisting of cellulose acetate, cellulose acetate propionate and cellulose acetate butyrate and combinations thereof.

14. The flooring article of claim 10 wherein said at least one cellulose ester is a combination of two or more cellulose esters.

15. The flooring article of claim 10 wherein said epoxidized bio-derived oil is epoxidized soybean oil.

16. A flooring article comprising at least one layer, wherein said at least one layer is a calendered layer.

17. A plasticized polymer flooring article of a least one layer, said at least one layer comprising at least one plasticizer and at least one polymer, wherein at least 77% by weight of the total sum weight of the plasticizer plus the polymer of said layer is bio-derived material.

18. The plasticized polymer flooring article of claim 17 wherein said polymer comprises a cellulose ester.

19. The plasticized polymer flooring article of claim 17 wherein said plasticizer comprises epoxidized bio-derived oil.
